(19) United States
(12) Patent Application Publication
(10) Pub. No.: US 2021/0087655 A1
(43) Pub. Date: Mar. 25, 2021

(54) FASTENER MADE OF ALUMINIUM ALLOY COMPRISING SCANDIUM

(71) Applicant: NEWFREY LLC, New Britain, CT (US)

(72) Inventors: Sivakumar RAMASAMY, Rochester, MI (US); Gnanasekar THIYAGARAJAN, Friedrichsdorf (DE); Timothy James LANGAN, Catonsville, MD (US)

(21) Appl. No.: 17/071,405

(22) Filed: Oct. 15, 2020

Related U.S. Application Data
(63) Continuation of application No. PCT/EP2019/059927, filed on Apr. 17, 2019.

(30) Foreign Application Priority Data
Apr. 18, 2018 (EP) 18167947.3

(51) Int. Cl. C22C 21/06; F16B 19/10; F16B 33/00; F16B 37/12; F16B 37/06; F16B 19/08; F16B 31/06

(52) U.S. Cl. CPC C22C 21/06; F16B 19/1072; F16B 33/008; F16B 31/06; F16B 37/061; F16B 19/086; F16B 37/122

(57) ABSTRACT

A fastener for securing at least a first component and a second component together, the fastener comprising: a securing portion adapted to be secured to the first and/or the second component, and a guiding portion adapted to be guided by a manipulator or a tool in order to set the securing portion in the first and/or the second component, wherein the securing portion and the guiding portion form a one-piece element made of one unique aluminium alloy having a composition between 0.03 and 0.55 wt % Scandium.

### CROSS-REFERENCE TO RELATED APPLICATIONS

This application is a continuation of international PCT/EP2019/059927, filed Apr. 17, 2019 which claims priority from European Patent Application No. 18167947.3, filed Apr. 18, 2018, the disclosures of which are incorporated herein by reference in their entirety.

### BACKGROUND OF THE INVENTION

The present invention is directed to fasteners made of aluminium alloy comprising scandium as a constituent. The fastener can be of any type, and more particularly of any shape and form from nails to rivets, bolts, screws and nuts. More particularly, the fastener is adapted to secure at least a first component and a second component together, temporarily or permanently. The fastener comprises a securing portion adapted to be secured to the first and/or the second component, and a guiding portion adapted to be guided by a manipulator and/or a tool in order to set the securing portion in the first and/or the second component.

In several industries, and notably for automotive and industrial applications, fasteners are indispensable components. In the automotive industry for example, fastener are indispensable components to assemble together vehicle body panels and/or different components to vehicle bodies.

A major goal of the automotive manufacturers is to reduce the weight of passenger cars. The structural body of a vehicle is a vehicle's largest structure, and therefore ideal for weight reduction considerations to respond to environmental concerns, notably to reduce carbon emissions. The implementation of assembly processes or assembly elements (for instance fasteners) minimizing the body weight of the vehicle is a key characteristic to achieve a reduced weight, without sacrificing vehicle dynamics, durability and crash worthiness.

As a concrete measure of lightweight, it is effective to replace steel parts by light alloy such as aluminium alloy or magnesium alloy.

For example, when an automotive engine or transmission case should be constructed by using a magnesium or aluminium alloy to achieve lightweight, it is desirable to change fastening parts (bolts, rivets, nuts, for example) made of steel for their fastening for aluminium alloy-based parts in view of prevention of electrolytic corrosion and weight reduction.

Document EP3121464 for example discloses a fastener, for instance a bolt, adapted to fasten a plurality of members. The fastener includes two portions. The first portion is made of a first aluminium alloy including between 0.005 wt % and 5.0 wt % zinc and between 0.6 wt % and 2.0 wt % magnesium. The second portion is made in a second aluminium alloy comprising between 2.0 wt % and 5.0 wt % magnesium and between 5.0 wt % and 10 wt % zinc. The second portion is joined to the first portion. Such fastener with two different portions made of two different materials are particularly complex to manufacture.

Document JP11172359 is directed to the production of a screw made of an aluminium alloy containing 0.5 to 1.5% Mg, 0.5 to 1.5% Si, 0.5 to 1.5% Cu and may also notably comprise 0.5 wt % Sc. Such alloy allows the production of a screw with particular tensile strength regulation and torsional strength regulation. However, such aluminium alloy cannot be employed for any kind of fasteners and necessitate several treatments. US2004140019 discloses aluminium alloy rivets containing aluminium blended with a secondary metal and up to 10 wt % of a tertiary metal which can be for instance Scandium for producing a rivet with high stability. US20120055588 discloses also an alloy composition which can be used for fastener bodies. However, US2004140019 and US20120055588 both propose several lists with several components to be blended together and with an important composition range, such that the selection of a particular composition specific for fasteners notably in the automotive industry is not possible.

Besides, numerous fasteners are used today to secure functional components or parts to the vehicle body. Reducing the weight of such fasteners shall significantly impact the global weight of a vehicle.

Therefore, the need still remains to provide a light and corrosion resistant fastener, made in a material having a strength high enough to correctly secure the components, and able to be formed with conventional manufacture methods for fastener, notably by cold-forming.

### BRIEF SUMMARY OF THE INVENTION

It is hence an object of the present invention to at least alleviate the aforementioned shortcomings. More particularly one objective of the present invention is to provide a fastener or fastening device easy to manufacture, reliable and strong enough to be used for fastening parts, for several applications, including, but not limited to automotive and industrial fasteners, notably fasteners used in aerospace application or for vehicle parts.

To this aim, according to the invention, it is provided a fastener for securing at least a first component and a second component together, the fastener comprising:—a securing portion adapted to be secured to the first and/or the second component, and—a guiding portion adapted to be guided by a manipulator or a tool in order to set the securing portion in the first and/or the second component, wherein the securing portion and the guiding portion form a one-piece element made of one unique aluminium alloy having a composition including between 0.03 and 0.55 wt % Scandium. More particularly, the composition is as follow: as follow:

Magnesium (Mg): 4.0+/−1.6 wt %

Manganese (Mn): 0.21+/−0.1 wt %

Scandium (SC): between 0.03 and 0.55 wt %

Zirconium (Zr): 0.15+0.15/−0.05 wt %

Zinc (Zn): 0.21+/−0.1 wt %

Aluminium (Al): Remaining wt %

The aluminium alloy may also comprise incidental elements and inevitable impurities.

For example, fasteners such as threaded and/or blind fasteners, internal or external are considered. Besides, the fasteners can allow a permanent joining and/or a temporary joining. More particularly, the fasteners can be screws, nuts, bolts, rivets and/or blind fasteners, as notably used in the automotive industry. The fastener is notably a cold form fastener.

The applicant, in aim to achieve the above objective, conducted extensive studies regarding alloy compositions and constituents adapted to be used for fasteners. The studies revealed notably that the special rare earth element scandium (Sc) as a constituent in an aluminium alloy, and in a particular proportion, allows the manufacture of a fastener meeting all the necessary technical features. More particularly, the fastener as described above has a high strength and light weight. Tests and experiences have notably shown that a proportion of Scandium in the range of 0.03 to 0.55 wt % enable a correct cold forming manufacture process. The strength needed for the fastener to correctly secure the components is increased. Such aluminium alloy with scandium demonstrates also good welding properties.

According to an embodiment, the concentration of Scandium is between 0.05 and 0.20 wt %, for example between 0.10 and 0.20 percentage by weight. The concentration of Scandium may be of about 0.15 wt %. Such concentration of scandium is notably optimal to create enough ductility and high strength development during forming, for example cold forming, and to avoid any micro-cracking during a cold forming process. Such ranges allow a good compromise between material properties and material costs. According to another embodiment, the concentration of scandium is of 0.13+/−0.02 wt %. According to another embodiment, the concentration of Scandium is between 0.07 and 0.13 wt %. Such range allows to limit the amount of Scandium, which is an expensive material, in the aluminium alloy without highly decreasing the ductility and high strength development during forming.

According to an embodiment, the aluminium alloy contains, in addition to aluminium and Scandium, the following constituents, in the concentrations indicated (in wt %):

| Mg | Mn | Zr | Zn |
|---|---|---|---|
| 5.5 + 0.1/−1.0 | 0.21 +/− 0.1 | 0.15 + 0.15/−0.05 | 0.21 +/− 0.1 |

According to an embodiment, a screw thread is formed on part of the securing portion. Depending on the application, the thread size may be between M0.5 and M39, more particularly between M3 and M39 according to ISO 965.

According to an embodiment, the fastener is a screw, a stud, a bolt, a nut, a blind rivet nut or a blind threaded insert.

According to an embodiment, the fastener is a blind rivet nut and the screw thread is formed on an inner surface of a hole formed at the centre of the fastener.

According to an embodiment, the fastener is a weld nut. More particularly, the fastener is a weld nut having a first surfaces adapted to be welded on a first component and a screw thread formed on an inner surface of a hole formed at the centre of the fastener, wherein the hole is adapted to receive the second component

According to an embodiment, the fastener is a self-piercing fastener.

According to an embodiment, the fastener is a self-piercing rivet.

According to an embodiment the tensile strength of the fastener is of at least 400 N/mm².

According to an embodiment, the Yield Strength of fastener is of at least 275 N/mm².

According to an embodiment, the density of the aluminium alloy is of less than 3.0 gms/cm³.

### BRIEF DESCRIPTION OF THE DRAWINGS

Other characteristics and advantages of the invention will readily appear from the following description of embodiments, provided as non-limitative examples, in reference to the accompanying drawings.

FIG. 1 shows a semi-sectional side view of a fastener according to a possible embodiment of the invention, the fastener being a blind rivet nut;

FIG. 2 shows a view of the blind rivet nut according to FIG. 1;

FIG. 3 shows a view of the blind rivet nut according to FIG. 1 secured to a first component;

FIG. 4 shows a second possible embodiment of a fastener according to the invention, the fastener being a self-piercing fastener, notably a self-piercing rivet;

FIG. 5 shows a third possible embodiment of a fastener according to the invention, the fastener being a stud having a threaded portion.

FIG. 6 shows a fourth possible embodiment of a fastener according to the invention, the fastener being a weld nut.

FIG. 7 shows a fifth embodiment of a fastener according to the invention, the fastener being a blind rivet.

### DETAILED DESCRIPTION OF THE PREFERRED EMBODIMENTS

On the different figures, the same reference signs designate identical or similar elements.

The figures schematically shows a fastener 10, 10′, 10″, 10′″, 10″″ according to several embodiments for securing at least a first component or element to a second component or element.

The fastener 10, 10′, 10″, 10′″ is a one-piece element and comprises a securing portion 12 and a guiding portion 14. The securing portion 12 is adapted to be secured to the first and/or the second component 16 (for sake of clarity, only one of the first or second component 16 is represented in FIG. 3). The guiding portion 14 is adapted to be guided by a manipulator and/or a tool in order to set the securing portion 12 in the first and/or the second component 16.

The fastener 10, 10′, 10″, 10′″, 10″″ is made of an aluminium based alloy comprising scandium. Hereinafter, the fastener 10, 10′, 10″, 10′″, 10″″ according to the invention consisting of such an aluminium alloy is explained in detail together with the effects of alloy elements (or constituents) and reason for their limitation. In the present description, “wt %” shall represent the percentage by weight or mass unless otherwise indicated.

The scandium based aluminium alloy comprises the following elements or constituents in percent by weight:

Magnesium (Mg): 4.0+/−1.6 wt %

Manganese (Mn): 0.21+/−0.1 wt %

Scandium (Sc): between 0.03 and 0.55 wt %

Zirconium (Zr): 0.15+0.15/−0.05 wt %

Zinc (Zn): 0.21+/−0.1 wt %

Aluminium (Al): Remaining wt %

Thus, the main element of the alloy remain the aluminium (Al) and the aluminium content depends on the contents of the others elements or constituents.

More particularly, the percentage by weight or mass of the Scandium is 0.15+/−0.05.

These alloy compositions have critically balanced alloy chemistries which result in unique blends of desirable properties, which are particularly suitable for use in producing fastener components. These properties include increased thermal stability, microstructural stability, and stress- and creep-rupture strength, notably at elevated temperatures.

The scandium (Sc) content may be about 0.15 percent by weight and, and advantageously scandium is present in an amount from 0.10 to 0.20 or more precisely from 0.12 percent to 0.18 percent by weight. The presence of the scandium in such proportions allows to obtain lightness, strength, improves corrosion resistance, formability and increases recrystallization temperature. Due to the fact that the Scandium is particularly expensive, the percent of scandium in the aluminium alloy should be limited.

The magnesium (Mg) content is present in an amount up to 5.6 percent by weight. For example, the magnesium may be present in an amount from 2.4 to 5.6 percent by weight. According to an embodiment, the magnesium may be about 5.5 percent by weight. The magnesium is an element that contributes to improve a room temperature strength. The tendency of magnesium to creep at high-temperatures is eliminated by the addition of scandium. In a first composition, the magnesium content is for example about 5.5+/−0.1 percent by weight. In a second composition, the magnesium content is for example about 4.75+/−0.10 percent by weight.

The Zinc (Zn) content is about 0.21 percent by weight and, and advantageously zinc is present in an amount from 0.11 percent to 0.31 percent by weight. The zinc is an element which contributes to the strengthening of the alloy through precipitation of Al—Mg—Zn based particles during aging. Zinc improves surface treatment properties, The Zinc should not exceed 0.31 percent by weight to avoid corrosion resistance and strength decrease.

The manganese (Mn) content is about 0.21 percent by weight and, and advantageously manganese is present in an amount from 0.11 percent to 0.31 percent by weight. The manganese has the effect of improving the seizure resistance with dies during forging. If the proportion of Manganese is less than 0.11 percent by weight, the seizure resistance properties are not sufficient to ensure a correct forming. On the contrary, a rate of manganese exceeding 0.31 percent by weight may adversely affect the tensile properties and workability of the alloy.

The zirconium (Zr) content is about 0.15 percent by weight and, and advantageously zirconium is present in an amount 0.10 to 0.30 percent by weight. The presence of the zirconium in such proportions allows a stabilizing effect of grain size. If the presence of zirconium is too low or too high, the tensile properties and stress corrosion cracking resistance needed for the fastener may not be obtained.

More particularly, the scandium based aluminium alloy may have, according to a first composition, constituents in percent by weight as follow:

| Mg | Mn | Sc | Zr | Zn | Al |
|---|---|---|---|---|---|
| 5.5 +/− 0.10 | 0.21 +/− 0.1 | 0.15 +/− 0.05 | 0.15 − 0.05/+0.15 | 0.21 +/− 0.1 | Remaining |

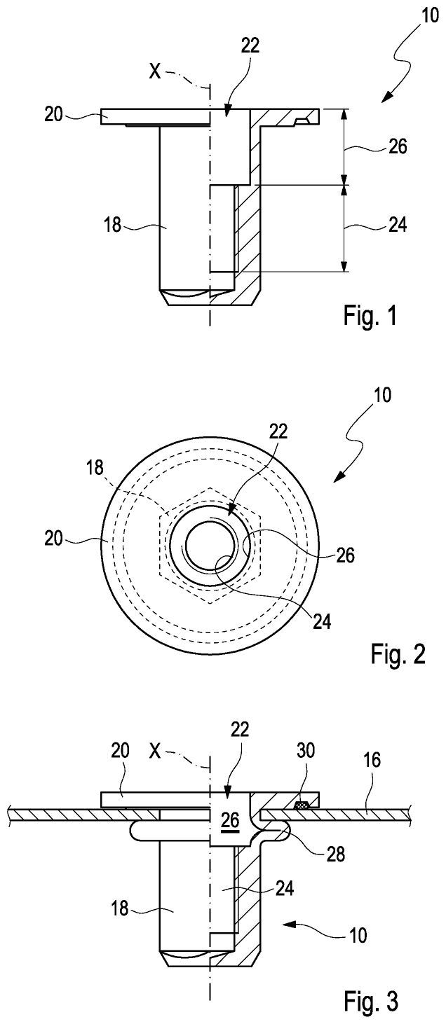

The first composition is particularly advantageous for fasteners such as blind rivet nuts, described notably below in reference to FIG. 1 to FIG. 3. However, the first composition may also be used for different type of fasteners as described above.

The scandium based aluminium alloy may have, according to a second composition, constituents in percent by weight as follow:

| Mg | Mn | Sc | Zr | Zn | Al |
|---|---|---|---|---|---|
| 4.75 +/− 0.10 | 0.21 +/− 0.1 | 0.15 +/− 0.05 | 0.15 − 0.05/+0.15 | 0.21 +/− 0.1 | Remaining |

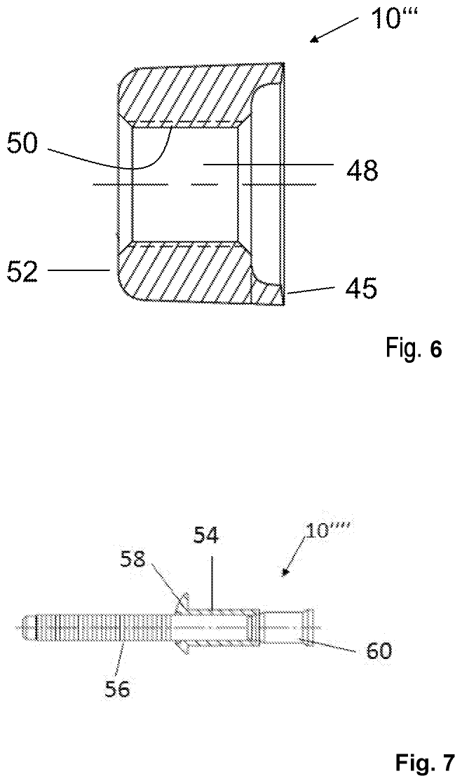

The second composition is particularly advantageous for fasteners such as weld nuts, described notably below in reference to FIG. 6. However, the second composition may also be used for different type of fasteners as described above.

The density of the material obtained may be below 3 gms/cm³ for instance may be about 2.7 grams/cm³.

The fasteners 10, 10′, 10″, 10′″, 10″″ represented in the figures is made of the aluminium alloy described above. The shape of the fasteners 10, 10′, 10″, 10″, 10′″ is for instance formed by a cold forming process. However, in other embodiments, other methods may be implemented. The fastener is for example produced by performing a wiredrawing process, a header process, and other known processes.

The fastener 10, 10′, 10″, 10′, 10″″ may have a tensile strength of minimum 400 Newton per square millimetres (N/mm²). For instance, the tensile strength is between 400 and 650 N/mm². The tensile strength is the maximum tension-applied load the fastener can support along its axis prior to or coinciding with its fracture.

The fastener 10, 10′, 10″, 10′, 10″″ may have a yield strength of minimum 250 N/mm². For instance the yield strength is between 250 and 400 N/mm² The yield strength corresponds to the maximal stress that can be applied to the fastener along its axis before or when it exhibits 0.2% plastic deformation.

The fastener can be a rivet nut 10. For example, as illustrated in FIG. 1 to FIG. 3, the fastener is a blind rivet nut 10. The blind rivet nut 10 can be anchored to a first or second component entirely from one side.

The blind rivet nut 10 represented in the drawing has an elongated shank 18 bearing a flange 20 at one end. The shank 18 may have a circular shape or the shape of a regular hexagonal or square or prism. The shank 18 can be conically pointed at its end opposed to the flange 20. Owing to a hexagonal outer contour, when the shank 18 is placed in a suitably shaped bore adapted in size to the cross-section of the shank 18, rotation of the shank in the bore is prevented. In other embodiments, longitudinal ribs may be provided on a portion of the outer contour (which may be circular) in order to prevent rotation of the shank in a bore. The pointed end facilitates introduction of the shank 20 into the bore.

The flange 20 may extend at right angles to the lengthwise axis X of the shank 18 and has the shape of a plane circular disk. Alternatively, the flange may have a polygonal shape, for example, square or hexagonal.

Through the flange 20 and the greater part of the length of the shank 18, a bore 22 extends, whose lengthwise axis coincides with the lengthwise axis of the shank 20. The bore 22 may be closed at the end of the shank. In other embodiments, the bore is a through hole and is not close at the end of the shank 18. The bore 22 may comprise a first bore segment 24 adjacent to the end of the shank opposite the flange 20, provided with an internal thread for screwing in a screw or bolt. The first bore segment 24 is adjoined by a second bore segment 26 extending to the top of the flange. The second bore segment 26 may have a constant diameter greater than the outside thread diameter of the internal thread of the first bore segment 24. However, in other embodiments, the diameter of the second bore segment is equal or smaller to the diameter of the first bore segment 24. The axial length of the second bore segment 26 may correspond to the smallest outside diameter of the shank, also known as the wrench width, but may alternatively be greater, for example, to make possible installation in a thicker part or the connection of several parts to each other.

The wall of the shank 18 surrounding the second bore segment 26 forms a deformable region capable of being deformed into a bulge 28 radially cambered outward for attachment of the blind rivet nut to a part as shown in FIG. 3. The smallest outside diameter of the shank 18 and the inside diameter of the bore segment are so coordinated with each other that the wall of the deformable region has a wall thickness of 4% to 6%, preferably 4.5% to 5%, of the smallest outside diameter D of the shank in the thinnest places. In this way, especially in connection with the production of the blind rivet nut as a cold-formed flow pressure part, a deformation behaviour of the deformable region is obtained that ensures a uniform contact of the flange 20 with the part connected with the blind rivet nut 10 and a dependable seal of the flange against the part. Deformations of the part that would lead to warping and non-uniform contact of the flange are avoided. By the specified ratio of wall thickness diameter, it is also brought about that the deformation bulge 28 formed attains an especially great radial extent, so that a stable anchorage of the blind rivet nut to the part can be obtained.

The flange of the blind rivet nut has an outside diameter corresponding to at least double the outside diameter of the wall. Here the thickness of the flange 20 is at least four to five times the least thickness of the wall. The peripheral contour of the flange is formed freely in the flow pressing of the blind rivet nut 10.

FIG. 3 shows the fastening of the blind rivet nut 10 to a sheet metal (also called component 16). For attachment, the first bore segment 24 of the blind rivet nut 10 may be first screwed onto the draw mandrel of a setting tool, and then the shank of the blind rivet nut is inserted into an opening in the part until the flange makes contact. Then the bore segment is moved by the draw mandrel in the direction of the flange, the setting tool coming to be supported on the flange. By this operation, the deformable region is compressed, so that it cambers radially outward and forms a bulge that comes to bear firmly on the part on the side away from the flange and thereby secures the blind rivet nut in the part.

To seal the blind rivet nut from the part, a sealing ring 30 may be arranged between the flange 20 and the part 16. The sealing ring 30 engages an annular groove of the flange, and is thereby held in a concentric position on the flange with respect to the blind rivet nut. The radially outward edge of the annular groove is somewhat lower than the thickness of the flange, forming an annular gap between the edge and the part, into which the sealing ring can enter when axially compressed between the blind rivet nut and the part during installation of the former.

In the embodiment depicted in FIG. 1 to FIG. 3, the securing portion 12 is formed by the outside portion of the shank and the bore. Indeed, a first or second component may be threaded into the second bore segment for its assembly to the fastener 10, whereas the bulge 28 formed on the outside portion of the shank 18 secures the fastener to the second or first component 16.

The blind rivet nut 10 may be obtained by a wire drawing process, as mentioned above.

The guiding portion 14 may be the first bore segment and/or the flange 20.

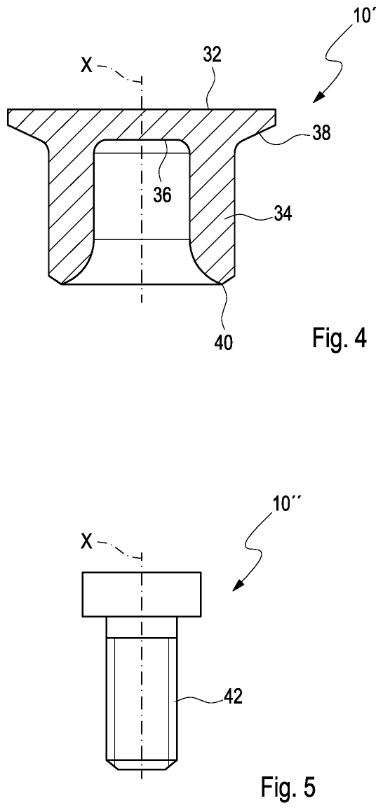

Another embodiment of a fastener 10′ according to the invention is depicted in FIG. 4. FIG. 4 shows a self-piercing fastener 10′, and more particularly a self-piercing rivet 10′. The self-piercing rivet 10′ is preferably formed rotationally symmetrically about a longitudinal axis X. The self-piercing rivet 10′ has a rivet head 32 and also a rivet shank 34, which adjoins the underside of the rivet head. The rivet head 32 has a top side, which is preferably configured as a planar, circular surface.

Furthermore, the rivet head 32 has a cylindrical outer head surface, which runs transversely to the head top side. Within the rivet shank, the rivet head 32 has a head underside 36, which in the present case is formed so as to taper in a frustoconical or rounded form. In other words, the rivet shank 34 therefore has a central borehole, which is in the form of a blind hole. The end face of this blind hole which lies opposite the head top side is referred to in the present case as head underside 36.

A further side of the rivet head 32 which is likewise remote from the head top side can be distinguished from the head underside 36. This side is referred to as shoulder underside 38. The rivet head 32 preferably has a shoulder which is peripheral about the longitudinal axis X and protrudes radially beyond the rivet shank 34. The shoulder underside 38 adjoins the outer head surface towards the top and the outer shank surface towards the bottom.

The rivet shank 34 is divided into a shank portion which adjoins the rivet head 32 and a cutting portion 40. The shank portion has a substantially hollow cylindrical form. The inner side thereof therefore has a cylindrical surface, which in the present case is referred to as inner shank surface. The cutting portion 40 has a comparatively tapered form at the bottom, since the self-piercing rivet 10′ is punched with said end shank side into the work pieces (or component(s)) to be connected during the riveting process.

In the embodiment of FIG. 4, the guiding portion 14 may be the head top side, whereas the securing portion 12 is formed by the rivet shank 34 and a portion of the rivet head 32 facing the work pieces.

FIG. 5 shows a further embodiment of a fastener according to the invention. More particularly, FIG. 5 depicts a threaded insert 10″. The threaded insert 10″ has a shaft and a head extending at one end of the shaft. The shaft has a portion comprising an external thread 42. The threaded insert can be a screw, a threaded stud, a clinching stud, a bolt . . . .

In the embodiment of FIG. 5, the securing portion 12 may be the threaded shaft. The guiding portion may be the head.

FIG. 6 shows another embodiment of the fastener 10′″ according to the invention. The fastener 10′″ is a weld nut, as seen in FIG. 6 varies slightly from a conventional nut in that it has on its lower face 45 a peripheral ridge 46. To improve weld performance this ridge 46 may taper to an annular apex, having a “V” shaped configuration. The weld nut 10′″ comprises a through hole 48 with an internal thread 50 adapted to receive a screw for example. The screw (not illustrated) can constitute the second component. The weld nut 10′″ is adapted to be welded to a work piece (not illustrated) which can consist of a thin metal sheet. More particularly, the lower face 45 of the weld nut 10′″ is adapted to be welded to a work piece wherein the screw may be inserted in the hole through the upper face 52.

FIG. 7 shows a further embodiment of the fastener. The fastener 10″″ is a blind rivet, which is composed of a rivet body 54 and a mandrel 56. The rivet body 54 is attached to the mandrel 56 and has an elongated shank with a through-bore, in which the mandrel is located. Formed at a head end of the shank is a flange 58, which takes the form of an annular disk and is intended to contact a work piece. The side of the flange facing away from the shank may be provided with a flat support surface, whose purpose is supporting the forward end of a rivet setting tool. The end of the mandrel may have a self-piercing section 60 adapted to bore a hole into a work piece.

As described above, the present invention may include various embodiments and the like not described herein. Various changes in the design and the like may be made without departing from the spirit of the invention defined by the claims.

Although exemplary embodiments of the present invention have been shown and described, it will be appreciated by those skilled in the art that changes may be made to these embodiments without departing from the principles and spirit of the invention, the scope of which is defined in the appended claims and their equivalents.

What is claimed is:

1. A fastener operable by a tool for securing at least a first component and a second component together, the fastener comprising:
a securing portion adapted to be secured to at least one of the first or the second component, and
a guiding portion adapted to be guided by the tool in order to set the securing portion in the at least one of the first or the second component,
wherein the securing portion and the guiding portion form a one-piece element made of one unique aluminium alloy having a composition as follow:
Magnesium (Mg): 4.0+/−1.6 wt %;
Manganese (Mn): 0.21+/−0.1 wt %;
Scandium (Sc): between 0.03 and 0.55 wt %;
Zirconium (Zr): 0.15+0.15/−0.05 wt %;
Zinc (Zn): 0.21+/−0.1 wt %; and
Aluminium (Al): Remaining wt %

2. A fastener according to claim 1, wherein the concentration of Scandium is between 0.10 and 0.20 percentage by weight.

3. A fastener according to claim 2 wherein the concentration of Scandium is 0.15 percentage by weight.

4. A fastener according to claim 1, wherein the concentration of Scandium is between 0.07 and 0.13 percentage by weight.

5. A fastener according to claim 1, wherein a screw thread is formed on part of the securing portion.

6. A fastener according to claim 1, wherein the fastener is one of a screw, a stud, a bolt, a nut, a blind rivet nut or a blind threaded insert or a blind rivet.

7. A fastener according to claim 1, wherein the fastener is a blind rivet nut and a screw thread is formed on an inner surface of a hole formed at the center of the fastener.

8. A fastener according to claim 1, wherein the fastener is a weld nut including a first surface adapted to be welded on the first component and further including a screw thread formed on an inner surface of a hole formed at the center of the fastener, and wherein the hole is adapted to receive the second component.

9. A fastener according to claim 1, wherein the fastener is a self-piercing fastener.

10. A fastener according to claim 1, wherein the fastener is a self-piercing rivet.

11. A fastener according to claim 1, wherein the tensile strength of the fastener is at least 400 N/mm².

12. A fastener according to claim 1, wherein the Yield Strength of the fastener is at least 250 N/mm².

13. A fastener according to claim 1, wherein the density of the fastener material is less than 3 gms/cm³.

14. A fastener according to claim 1, wherein the fastener is formed by a cold-forming process.
